(19) United States
(12) Patent Application Publication
(10) Pub. No.: US 2007/0019534 A1
(43) Pub. Date: Jan. 25, 2007

(54) Recording medium

(75) Inventor: Tetsuo Hosokawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/540,783

(22) Filed: Sep. 29, 2006

Related U.S. Application Data
(63) Continuation of application No. PCT/JP04/08041, filed on Jun. 9, 2004.

(51) Int. Cl. G11B 7/24

(52) U.S. Cl. 369/275.3

(57) ABSTRACT

The inventor observed the electric signal output from a photodetector in the readout of RAM information. It has been confirmed that the electric signal includes a reproduced waveform of a relatively larger first amplitude value and a reproduced waveform of a second amplitude value smaller than the first amplitude value. The reproduced waveform of the second amplitude value synchronizes with the reproduced waveform of the first amplitude value. The inventor revealed a correlation between the ratio between the first and second amplitude values and a birefringent difference between first and second birefringent values. The satisfaction of the correlation leads to a reliable realization of jitter equal to or smaller than 8% in the readout of information based on recording marks. The recording medium of this type enables realization of recordation and reproduction of information with a high accuracy based on the recording marks.

This is a continuation of International Application No. PCT/JP2004/008041, filed Jun. 9, 2004.

### BACKGROUND OF THE INVENTION

1. Field of the Invention:

The present invention relates to a recording medium including a substrate having a surface defining phase pit sequences and a magnetic film defining a recording mark on the surface of the substrate based on the direction of magnetization.

2. Description of the Prior Art:

A so-called concurrent ROM-RAM magneto-optical disk is well known as disclosed in Japanese Patent Application Publication No. 6-202820, for example. RAM (Random Access Memory) information can be written anytime into a magnetic recording film formed on the surface of a substrate in the magneto-optical disk in the manner similar to a general magneto-optical disk. Phase pits have been established on the surface of the substrate. The phase pits serve to hold ROM (Read Only Memory) information.

A laser beam is irradiated onto the magneto-optical disk for the readout of the ROM information. The irradiated laser beam reflects from the magneto-optical disk at various intensities. The light intensity depends on whether a phase pit exits or not. This variation in the light intensity is utilized to read out the ROM information. A laser beam is likewise irradiated onto the magneto-optical disk for the readout of the RAM information. The polarization plane rotates in the laser beam in response to the polar Kerr effect acting from the magnetic recording film. The rotation of the polarization plane is utilized to discriminate binary data or bit data contained in the RAM information. However, the readout of the ROM information and the RAM information cannot concurrently be achieved as expected.

### SUMMARY OF THE INVENTION

It is accordingly an object of the present invention to provide a recording medium having a magnetic film allowing discrimination of information in a recording mark with a sufficient accuracy regardless of minimization of the minimum pit length of the phase pits.

According to a first aspect of the present invention, there is provided a recording medium comprising: a substrate defining phase pit sequences on the surface of the substrate; and a magnetic film defining recording marks on the surface of the substrate based on the direction of magnetization, wherein the following relationship is established between an amplitude ratio a/b and a birefringent difference d[nm], the amplitude ratio a/b being derived between the maximum amplitude value b of an electric signal and the minimum amplitude value a of the electric signal, the birefringent difference d[nm] being derived between first and second birefringent values,

[Expression 1]
a/b≧0.0177d+0.2568 (1)
the first birefringent value being measured for a single pass of an optical beam passing through the substrate of an attitude rotated by 20 degrees from a reference plane perpendicular to the optical beam around a tangent line extending through the spot of the optical beam on the substrate, the second birefringent value being measured for a single pass of the optical beam passing through the substrate of an attitude rotated by 20 degrees from the reference plane around a radial line extending through the spot of the optical beam on the substrate, the electric signal being generated in a photodetector based on optical beams having passing through the magnetic film, the optical beams having polarization planes perpendicular to each other.

The inventor has observed the electric signal output from the photodetector as described above. An oscilloscope was employed for the observation. Duplex reproduced waveforms appeared on the screen of the oscilloscope. It is the situation different from the case where information is read out based on recording marks in a general manner. The duplex reproduced waveforms consist of a reproduced waveform having a relatively larger first amplitude value and a reproduced waveform having a second amplitude value smaller than the first amplitude value. The reproduced waveform of the second amplitude value synchronized with that of the first amplitude value. The inventor has revealed a correlation between the amplitude ratio and the birefringent difference. The amplitude ratio corresponds to the ratio between the first and second amplitude values, namely between the maximum and minimum amplitudes. The birefringent difference corresponds to the difference between the first and second birefringent values. It has been confirmed that establishment of [Expression 1] leads to a reliable realization of jitter equal to or smaller than 8% in the readout of information based on the recording marks. The recording medium of the type enables a reliable realization of recordation and reproduction of information with a sufficient accuracy based on the recording marks irrespective of a reduced minimum pit length of the phase pit.

In particular, the following relationship is preferably established:

[Expression 2]
a/b≧0.0185d+0.1918 (2)
The inventor has revealed that establishment of [Expression 2] leads to a reliable realization of jitter equal to or smaller than 8% in the readout of information based on the recording marks. Additionally, the following relationship is preferably established:
[Expression 3]
a/b≧0.0186d+0.1506 (3)
The inventor has revealed that establishment of [Expression 3] leads to a reliable realization of jitter equal to or smaller than 8% in the readout of information based on the recording marks.

Simultaneously, the following relationship is preferably established:

[Expression 4]
a/b≦0.8 (4)
The inventor has revealed that establishment of [Expression 4] leads to a reliable realization of jitter equal to or smaller than 8% in the readout of information based on the phase pit sequences, even when the phase pit sequences have the minimum pit length smaller than one according to the standard of a compact disk (CD).

According to a second aspect of the present invention, there is provided a recording medium comprising: a substrate defining phase pit sequences on the surface of the substrate; and a magnetic film defining recording marks on the surface of the substrate based on the direction of magnetization, wherein the following relationship is established between a birefringent difference d[nm] and the product of an optical depth Pd[λ] of the phase pits in the phase pit sequences and an inclination angle S of an inclined surface defined in the phase pits, the birefringent difference d[nm] being derived between first and second birefringent values,

[Expression 5]
Pd·S≦−0.2236d+8.8616 (5)
the first birefringent value being measured for a single pass of an optical beam passing through the substrate of an attitude rotated by 20 degrees from a reference plane perpendicular to the optical beam around a tangent line extending through a spot of the optical beam on the substrate, the second birefringent value being measured for a single pass of the optical beam passing through the substrate of an attitude rotated by 20 degrees from the reference plane around a radial line extending through the spot of the optical beam on the substrate, and λ standing for the wavelength of an optical beam for readout of information.

The inventor has revealed a correlation between the product of the optical depth Pd and the inclination angle S and the birefringent difference between the first and second birefringent values. The inventor has revealed that establishment of [Expression 5] leads to a reliable realization of jitter equal to and smaller than 8% in the readout of information based on the recording marks. The recording medium of the type enables a reliable realization of recordation and reproduction of information with a sufficient accuracy based on the recording marks irrespective of a reduced minimum pit length of the phase pit.

In particular, the following relationship is preferably established:

[Expression 6]
Pd·S≦−0.2338d+9.6817 (6)
The inventor has revealed that establishment of [Expression 6] leads to a reliable realization of jitter equal to or smaller than 8% in the readout of information based on the recording marks. Additionally, the following relationship is preferably established: [Expression 7]
Pd·S≦−−0.2345d+10.201 (7)
The inventor has revealed that establishment of [Expression 7] leads to a reliable realization of jitter equal to or smaller than 8% in the readout of information based on the recording marks.

Simultaneously, the following relationship is preferably established:

[Expression 8]
Pd·S≧2.00 (8)
The inventor has revealed that establishment of [Expression 8] leads to a reliable realization of jitter equal to or smaller than 8% in the readout of information based on the phase pit sequences, even when the phase pit sequences have the minimum pit length smaller than one according to the standard of a compact disk (CD).

The minimum mark size of the recording marks is preferably set larger than the minimum pit length of the phase pits in the phase pit sequences in any of the aforementioned recording media. The recording medium allows minimization of the influence of the phase pit sequences during the readout of information based on the recording marks as compared with a recording medium having the minimum pit length equal to the minimum mark size. Jitter can be reduced in the discrimination of the recording marks. Information can be read out based on the recording marks with a sufficient accuracy even when the minimum pit length gets smaller in the phase pit sequences. In general, when the minimum pit length is set smaller in the phase pit sequences, the optical depth of the phase pits is set larger. A larger optical depth of the phase pits causes an increase in jitter in the discrimination of the recording marks. In other words, accuracy gets deteriorated in the discrimination of the recording marks. If the minimum mark size is set larger than the minimum pit length as defined, the deterioration of the accuracy can be minimized.

In particular, the minimum mark size is preferably set equal to the product of the minimum pit length and an integral. The recording medium enables generation of a clock signal based on the information read out from the phase pit sequences. The clock signal can be utilized for the recordation and reproduction of information based on the recording marks. The clock signal generated from the phase pit sequences reflects fluctuation in the speed of the movement of the phase pit sequences, so that the influence of the fluctuation in the speed of the movement can thus be eliminated in the recordation and reproduction of information based on the recording marks. This results in realization of the recordation and reproduction of information based on the recording marks with a higher accuracy.

The interval may be set in the range from 1.0 μm to 1.2 μm between the adjacent ones of the phase pit sequences. The minimum pit length may be set in the range from 0.55 μm to 0.65 μm. The set interval and minimum pit length contribute to establishment of the phase pits at a higher density. The inventor has revealed that information can be read out with a sufficient accuracy based on the phase pit sequences and the recording mark sequences even when the phase pits are arranged in a packed manner at a higher density.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a perspective view schematically illustrating a magneto-optical disk as an example of a recording medium according to the present invention;

FIG. 2 is an enlarged partial sectional view taken along the line 2-2 in FIG. 1;

FIG. 3 is an enlarged perspective view schematically illustrating the structure of the substrate of the magneto-optical disk;

FIG. 4 is an enlarged partial sectional view taken along the line 4-4 in FIG. 3;

FIG. 5 is a schematic view for explaining a method of measuring the birefringence;

FIG. 6 is a schematic view schematically illustrating the structure of the magneto-optical disk drive;

FIG. 7 is an enlarged partial perspective view showing the positional relationship between a phase pit sequence and the polarization plane of a laser beam;

FIG. 8 is a block diagram schematically illustrating the structure of a signal processing unit;

FIG. 9 is a view schematically illustrating the reproduced waveforms of RAM information displayed on an oscilloscope;

FIG. 10 is a graph showing the relationship between the ratio between the maximum and minimum amplitude values and birefringent difference;

FIG. 11 is a graph showing the relationship between the ratio between the maximum and minimum amplitude values and the product of the optical depth of the phase pits and the angle of the inclined surface of the phase pits;

FIG. 12 is a graph showing the relationship between birefringent difference and the product of the optical depth of the phase pits and the angle of the inclined surface of the phase pits; and

FIG. 13 is a graph showing the relationship between jitter and the ratio between the maximum and minimum amplitude values.

### DESCRIPTION OF THE PREFERRED EMBODIMENT

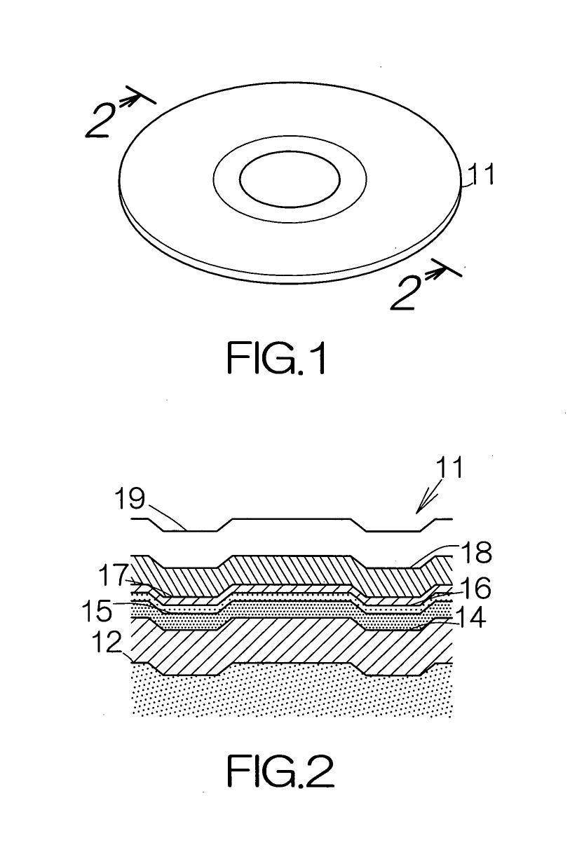

FIG. 1 illustrates a magneto-optical disk 11 as an example of a recording medium according to the present invention. The magneto-optical disk 11 is a so-called concurrent ROM-RAM magneto-optical disk. The diameter of the magneto-optical disk 11 is set at 120 mm, for example. It should be noted that such a medium might take the shape of a card or the like in place of the shape of a disk.

FIG. 2 schematically illustrates a sectional view of the magneto-optical disk 11. The magneto-optical disk 11 includes a substrate 12 in the shape of a disk. The substrate 12 is made of a transparent material. The transparent material may be a resin material such as polycarbonate, amorphous polyolefin, or the like. Injection molding is employed to form the substrate 12. An undercoat film 14, a magnetic recording film 15, an auxiliary magnetic film 16, an overcoat film 17, a reflection film 18 and a protection film 19 are formed on the surface of the substrate 12 in this sequence. The undercoat film 14 may be made of a transparent material such as SiN. The magnetic recording film 15 may be made of a transparent magnetic material such as TbFeCo. Likewise, the auxiliary magnetic film 16 may be made of a transparent magnetic material such as GbFeCo. The overcoat film 17 may be made of a transparent material such as SiN. The reflection film 18 may be made of a material such as aluminum capable of establishing a mirror surface. The protection film 19 may be made of a UV-curable resin material, for example.

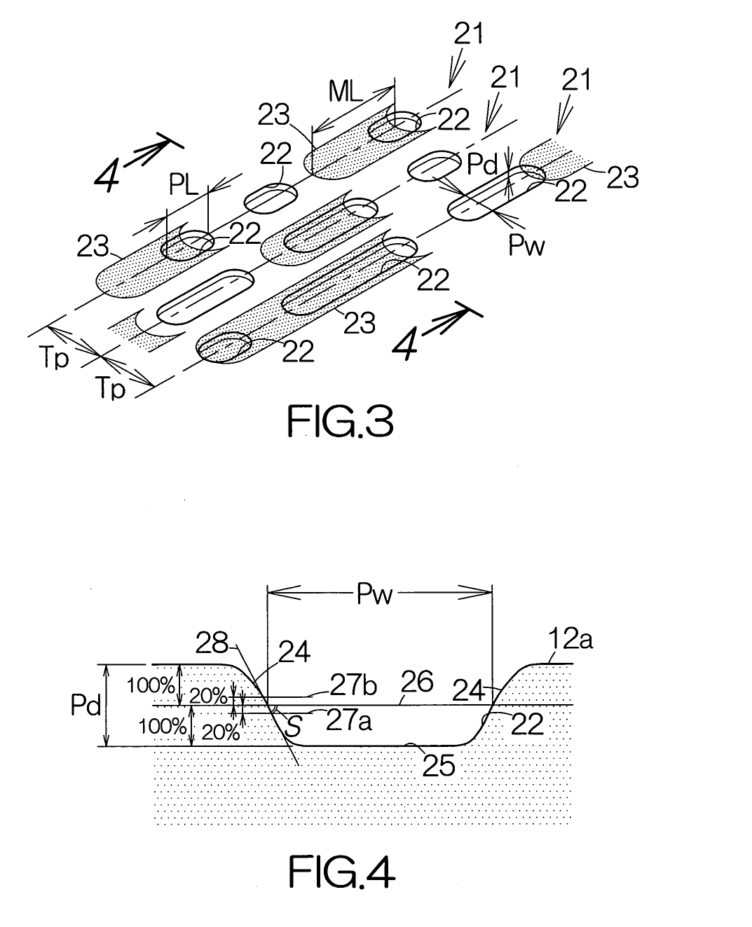

As shown in FIG. 3, phase pit sequences 21 are formed on the surface of the substrate 12. The individual phase pit sequence 21 includes phase pits 22. The individual phase pit 22 is formed as a depression having an optical depth Pd. Each of the phase pit sequences establishes a recording track. The phase pit sequences 21 are arranged at intervals called “track pitch” Tp in the radial direction of the substrate 12. The track pitch Tp maybe set in the range from 1.0 μm to 1.2 μm, for example. The minimum pit length PL may be set in the range from 0.55 μm to 0.65 μm, for example. The phase pits 22 can thus be formed in the magneto-optical disk 11 with a higher density. It should be noted that the track pitch Tp and the minimum pitch length PL may take any values in response to a change of other conditions.

The undercoat film 14, the magnetic recording film 15, the auxiliary magnetic film 16, the overcoat film 17, the reflection film 18 and the protection film 19 are formed on the entire surface of the substrate 12. The phase pit sequences 21 are thus covered with the undercoat film 14, the magnetic recording film 15, the auxiliary magnetic film 16, the overcoat film 17, the reflection film 18 and the protection film 19. Recording marks 23 are established in the magnetic recording film 15 on the phase pit sequences 21. The mirror surface of the reflection film 18 is thus opposed to the phase pit sequences 21 and the recording marks 23. In the case where the downward magnetization is established in the entire magnetic recording film 15, for example, the upward magnetization is established in the recording marks 23. Such reversal of the magnetization allows establishment of the recording marks 23. The recording marks 23 respectively have the minimum mark size ML set larger than the minimum pit length PL. Here, the minimum mark size ML of the recording marks 23 is set equal to the product of the minimum pit length PL and an integer.

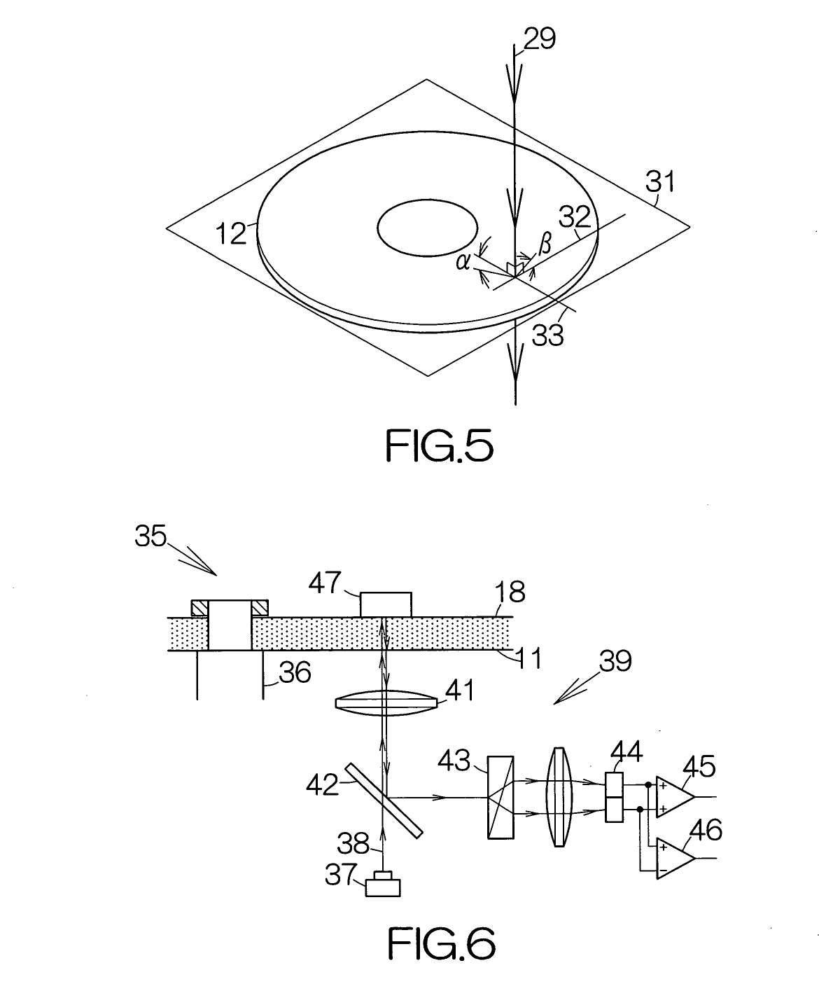

The product of the optical depth Pd[λ] of the phase pit 22 and an inclination angle S[°] of an inclined surface defined in the phase pit 22 is set in the range from 1.0 to 8.5 in the magneto-optical disk 11. As shown in FIG. 4, the inclined surface 24 is formed along the contour of the phase pit 22. The phase pit 22 has the bottom 25 depressed by the optical depth Pd from the surface 12a of the substrate 12. The inclination angle S is determined at the half of the optical depth Pd, which is hereinafter referred to as “half depth”. A reference plane 26 is defined at the half depth in parallel with the surface 12a of the substrate 12 for the determination of the inclination angle S. First and second planes 27a, 27b are defined in parallel with the reference plane 26. The first plane 27a is located between the reference plane 26 and the bottom 25 at a position distanced from the reference plane 26 by one fifth the half depth. The second plane 27b is located between the reference plane 26 and the surface 12a of the substrate 12 at a position distanced from the reference plane 26 by one fifth the half depth. A measurement plane 28 is defined based on the positions of the inclined surface 24 on the first plane 27a and the second plane 27b. The inclination angle S of the inclined surface 24 is measured between the measurement plane 28 and the reference plane 26.

Difference is set smaller than 25 nm between first and second birefringent values in the magneto-optical disk 11. This difference is hereinafter referred to as a “birefringent difference”. In this case, a single pass of a first inclined optical beam is utilized to measure the first birefringent value of the substrate 12. A single pass of a second inclined optical beam is likewise utilized to measure the second birefringent value of the substrate 12. As shown in FIG. 5, for example, the substrate 12 is kept, for the measurement of the first birefringent value, in an attitude rotated by an inclination angle α equal to 20 degrees from a reference plane 31 perpendicular to an optical beam 29 around a tangent line 32 tangent to the phase pit sequence 21 passing through the spot of the optical beam 29 on the substrate 12. Likewise, the substrate 12 is kept, for the measurement of the second birefringent value, in an attitude rotated by an inclination angle β equal to 20 degrees from the reference plane 31 around a radial line 33 passing through the spot of the optical beam 29 on the substrate 12. A conventional birefringent measurement instrument such as ADR-200B®, distributed from ORC Manufacturing Co., Ltd., may be employed to measure the first and second birefringent values.

The magneto-optical disk 11 enables establishment of so-called ROM (Read Only Memory) information based on the phase pit sequences 21. A laser beam is irradiated along the phase pit sequences 21 for the readout of the ROM information. The light intensity of light reflected from the magneto-optical disk 11 varies in response to the inexistence and presence of the phase pit 22. This change in the light intensity is utilized to discriminate binary data. Here, the ROM information corresponds to image information recorded in the magneto-optical disk 11. A data compression method such as MPEG may be employed to reduce the volume of the image information. The magneto-optical disk 11 likewise enables establishment of so-called RAM (Random Access Memory) information based on the recording marks 23. A laser beam is irradiated along the phase pit sequences 21 for the readout of the RAM information. The polarization plane of the laser beam rotates in response to the polar Kerr effect of the magnetic recording film 15. This rotation of the polarization plane is utilized to discriminate binary data. A laser beam is irradiated on the magnetic recording film 15 along the phase pit sequences 21 for the recordation of the RAM information. A magnetic field is simultaneously applied to the magnetic recording film 15 at a predetermined intensity. Magnetization is established in a specific direction in response to a rise in the temperature of the magnetic recording film 15 and reversal of the magnetic field. Here, the RAM information corresponds to sonant information recorded in the magneto-optical disk 11. A data compression method such as MP3 may be employed to reduce the volume of the sonant information.

Next, a brief description will be made on a method of making the magneto-optical disk 11. The substrate 12 is first molded. An injection molding machine is utilized, for example. Fluid such as fluid polycarbonate, fluid polyolefin, or the like, is poured into a mold or stamper. The stamper serves to form the phase pits 22 on the surface of the substrate 12. The thickness of the substrate 12 is set at 1.2 mm, for example. When polycarbonate is employed as the material of the substrate 12, the substrate 12 may be subjected to annealing treatment after the injection molding. The annealing treatment contributes to a reduction in the birefringent difference of the substrate 12. The temperature of the annealing treatment is preferably set equal to or lower than 120 degrees Celsius. The temperature higher than 120 degrees Celsius causes a large change in the properties of the substrate 12. It should be noted that any method different from the described one may be employed to form the substrate 12.

The undercoat film 14, the magnetic recording film 15, the auxiliary magnetic film 16, the overcoat film 17, the reflection film 18 and the protection film 19 are thereafter sequentially formed on the surface of the substrate 12. Sputtering is employed to form the films 14-19, for example. A vacuum equal to or smaller than 5 e⁻⁵ [Pa] is set in each chamber of a sputtering apparatus.

The substrate 12 is first transported into a first chamber. A Si target is set in the first chamber. Ar gas and N₂ gas are introduced into the first chamber. Reactive sputtering is effected in the first chamber to form a SiN film or undercoat film 14. The thickness of the SiN film is set at 80.0 nm approximately, for example.

The substrate 12 is then transported into a second chamber. The magnetic recording film 15 and the auxiliary magnetic film 16 are sequentially formed on the surface of the substrate 12 in the second chamber. Here, the magnetic recording film 15 is made of a Tb₂₂ (Fe₈₈Co₁₂) ₇₈ alloy film having the thickness of 30.0 nm approximately, for example. The auxiliary magnetic film 16 is made of a Gd₁₉ (Fe₈₀Co₂₀) ₈₁ alloy film having the thickness of 4.0 nm approximately, for example.

The substrate 12 is again transported into the first chamber. The overcoat film 17 and the reflection film 18 are sequentially formed on the surface of the auxiliary magnetic film 16. The overcoat film 17 is made of a SiN film having the thickness of 5.0 nm approximately, for example. The reflection film 18 is made of an aluminum film having the thickness of 50.0 nm approximately, for example. The protection film 19 is formed on the reflection film 18. The protection film 19 may be made of a UV-curable resin coat, for example. The magneto-optical disk 11 is in this manner formed. It should be noted that the materials may be selected from any general materials suitable for a recording medium for optical magnetic recording in place of the described ones.

A magneto-optical disk drive 35 is employed to effect recording/reproducing operations on the magneto-optical disk 11. The magneto-optical disk drive 35 includes a spindle 36 designed to support the magneto-optical disk 11, as shown in FIG. 6, for example. The spindle 36 serves to drive the magneto-optical disk 11 for rotation around the longitudinal axis of the spindle 36.

The magneto-optical disk drive 35 includes a light source or semiconductor laser diode 37. The semiconductor laser diode 37 is designed to emit an optical beam of the linear polarization, namely a laser beam 38. When the magneto-optical disk 11 is set on the spindle 36, a so-called optical system 39 serves to direct the laser beam 38 to the magneto-optical disk 11.

The optical system 39 includes an objective lens 41 opposed to the surface of the magneto-optical disk 11, for example. A beam splitter 42 is located between the semiconductor laser diode 37 and the objective lens 41, for example. The laser beam 38 from the semiconductor laser diode 37 passes through the beam splitter 42. The laser beam 38 is then irradiated onto the magneto-optical disk 11 through the objective lens 41. The objective lens 41 serves to form a minute beam spot on the surface of the magneto-optical disk 11. The laser beam 38 passes through the substrate 12, the undercoat film 14, the magnetic recording film 15, the auxiliary magnetic film 16 and the overcoat film 17. The laser beam 38 finally reaches the reflection film 18. The reflection film 18 reflects the laser beam 38. The reflected laser beam 38 is directed to the beam splitter 42 through the objective lens 41.

A two-beam Wollaston 43 is opposed to the beam splitter 42. The beam splitter 42 serves to reflect the laser beam 38 returning from the magneto-optical disk 11. The laser beam 38 is directed to the two-beam Wollaston 43 through the beam splitter 42. The two-beam Wollaston 43 splits the laser beam 38 into two beams having the polarization planes perpendicular to each other.

A bisected photodetector 44 is placed behind the two-beam Wollaston 43. The bisected photodetector 44 is designed to detect the laser beam 38 for each polarization plane after the split at the two-beam Wollaston 43. The laser beam 38 is converted into an electric signal for each polarization plane. The electric signals for the polarization planes are then summed at a summing amplifier 45. The intensity is detected for the overall laser beam 38. The ROM information is in this manner read out based on the output from the summing amplifier 45. The electric signals are also subjected to subtraction at a subtracting amplifier 46. The rotation is detected between the polarization plane of the laser beam 38 reflecting from the magneto-optical disk 11 and the polarization plane of the laser beam 38 before the reflection. The RAM information is in this manner readout based on the output from the subtracting amplifier 46.

A magnetic head slider 47 is opposed to the objective lens 41. An electromagnetic transducer is mounted on the magnetic head slider 47. The electromagnetic transducer may be located on the extension of the path of the laser beam 38 directed from the objective lens 41 to the magneto-optical disk 11. The irradiation of the laser beam 38 causes a rise in the temperature of the magnetic recording film 15. The electromagnetic transducer serves to apply a magnetic field for recordation to the magnetic recording film 15. The rise in the temperature allows the magnetization to rotate in the magnetic recording film 15 in response to the direction of the magnetic field for recordation. The RAM information is in this manner written into the magnetic recording film 15. It should be noted that a so-called optical modulation recording may be employed in place of the magnetic modulation recording as described.

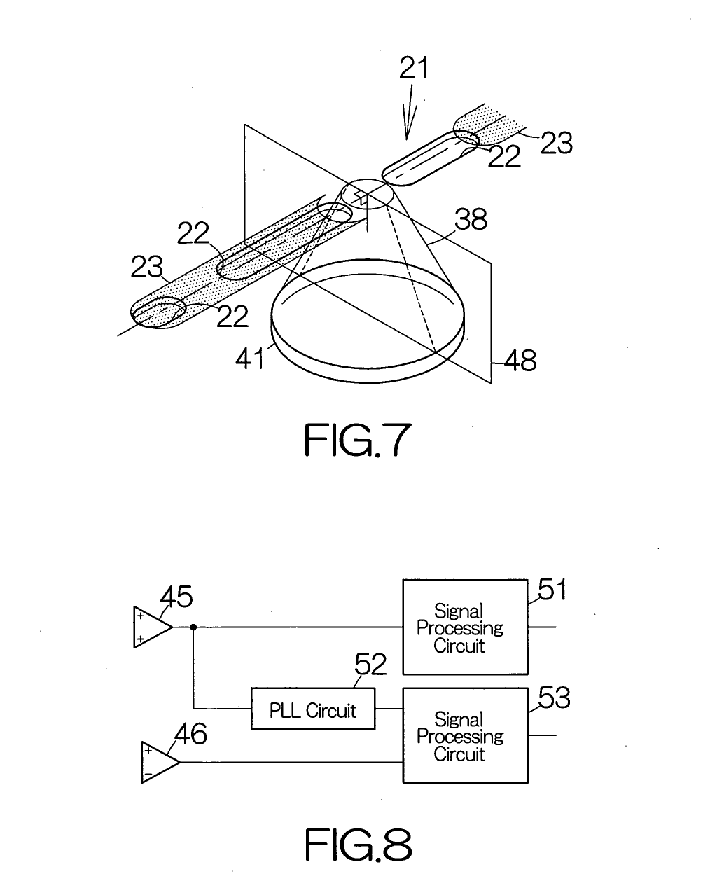

As shown in FIG. 7, the polarization plane 48 of the laser beam 38 is set perpendicular to the phase pit sequence 21 in the magneto-optical disk drive 35. In other words, the laser beam 38 of a so-called perpendicular polarization is applied to the phase pits 22 and the magnetic recording film 15. The laser beam 38 of the perpendicular polarization contributes to a reduction in jitter in the readout of the ROM and RAM information.

As shown in FIG. 8, the output from the summing amplifier 45 is supplied to a signal processing circuit 51 for the readout of the ROM information, for example. The output from the summing amplifier 45 is also supplied to a PLL (phase-lockedloop) circuit 52. The PLL circuit 52 generates a clock signal based on the data string of the ROM information supplied from the summing amplifier 45. The clock signal is supplied to a signal processing circuit 53. The output from the subtracting amplifier 46 is also supplied to the signal processing circuit 53. The signal processing circuit 53 is designed to detect binary date in the output from the subtracting amplifier 46 in synchronization with the clock signal from the PLL circuit 52. The minimum mark size ML of the recording mark 23 is the product of the minimum pit length PL of the phase pit 22 and an integer, so that the binary date can reliably be read out from the recording marks 23, as long as the recording marks 23 are established in synchronization with the clock signal. The clock signal from the PLL circuit 52 follows the fluctuation of the rotation of the magneto-optical disk 11. The influence of the fluctuation can thus significantly be eliminated when the recording marks 23 are to be read/written.

When the RAM information is to be read out from the magneto-optical disk 11 in the aforementioned magneto-optical disk drive 35, for example, the amplitude ratio a/b is set in the range from 0.40 to 0.90 between the minimum amplitude value a and the maximum amplitude value b of the electric signal output from the subtracting amplifier 46. This results in a reliable realization of jitter equal to or smaller than 8% in the readout of the RAM information. Here, the maximum and minimum amplitude values b, a of the electric signal respectively depend on the reproduced waveforms displayed on an oscilloscope, as shown in FIG. 9, for example. When a continuous groove is formed in place of the phase pit sequence 21 in the same manner as in a general magneto-optical disk, only the reproduced waveform of the maximum amplitude value b is observed on the oscilloscope.

The inventor has observed the properties of the magneto-optical disk 11. The substrates 12 were prepared. The phase pit sequences 21 were formed on each of the substrates 12 based on the eight to fourteen modulation (EFM). The track pitch Tp was set at 1.1 μm. The width of the phase pits 22 was set at 0.55 μm. The minimum pit length PL was set at 0.60 μm. The actual depth of the phase pits 22 was individually set for the substrates 12 in the range from 38.0 nm to 121.0 nm. The inclination angle S of the inclined surface 24 of the phase pit 22 was selectively set in each of the substrates 12. The actual depth and the inclination angle S were adjusted by changing the thickness of the resist resin applied in the process of forming the stamper, by changing the exposure period of the deep-ultraviolet irradiated onto the molded substrates 12, and the like, for example. The ROM information is in this manner established based on the phase pit sequences 21.

The first substrate 12 was made of polycarbonate known as Panlite® ST-3000 distributed from Teijin Chemicals Limited. The annealing treatment was omitted after the injection molding. The first substrate 12 was allowed to have the birefringent difference equal to 43 nm. The second and third substrates 12 were likewise made of polycarbonate. The annealing treatment was effected on the substrates 12 for a period of one hour after the injection molding. The second substrate 12 was subjected to the annealing treatment at the temperature of 100 degrees Celsius. The second substrate 12 was allowed to have the birefringent difference equal to 34 nm. The third substrate 12 was subjected to the annealing treatment at the temperature of 120 degrees Celsius. The third substrate 12 was allowed to have the birefringent difference equal to 25 nm. The fourth substrate 12 was made of amorphous polyolefin known as Arton® D4810 distributed from JSR Corporation. The annealing treatment was omitted after the injection molding. The fourth substrate 12 was allowed to have the birefringent difference equal to 17 nm irrespective of the omission of the heat treatment. The inventor also prepared the fifth substrate 12 made of amorphous polyolefin known as ZEONEX® E28R distributed from ZEON Corporation. The annealing treatment was omitted after the injection molding. The fifth substrate 12 was allowed to have the birefringent difference equal to 10 nm approximately irrespective of the omission of the heat treatment. ADR-200B®, distributed from ORC Manufacturing Co., Ltd., was utilized for the measurement of the birefringent difference. The wavelength of the laser beam was set at 635 nm.

The inventor prepared the magneto-optical disks 11 based on the first to fourth substrates 12, respectively. The recording marks 23 were established in the magnetic recording film 15 based on the eight to fourteen modulation (EFM) in each of the magneto-optical disks 11. Magnetic field modulation recording was utilized. The wavelength λ of the laser beam was set at 650 nm. The numerical aperture NA of the objective lens was set at 0.55. The set wavelength λ and numerical aperture NA allow the laser beam to form a spot, having the spot diameter of 1.1 μm approximately, on the surface of the magnetic recording film 15 at the intensity of 1/e². The linear velocity was set at 4.8 [m/s]. The minimum mark size ML of 1.2 μm, 1.8 μm or 2.4 μm was selectively set for the individual magneto-optical disk 11. Adjustment was effected on the control of clock timing and the control of the laser beam so as to set the minimum mark size ML. The reflectance was set at 19% approximately for all the magneto-optical disks 11. Here, the inventor measured the reflectance of the laser beam reflected from the mirror surface of the reflection film 18 at a position off the phase pits 22. The RAM information was in this manner established based on the recording marks 23.

The ROM information was then read out from the phase pit sequences 21 of the magneto-optical disk 11. Jitter or ROM jitter was measured based on the obtained ROM information. The RAN information was also readout from the recording marks 23. Jitter or RAM jitter was measured based on the obtained RAM information. The wavelength λ of the laser beam was set at 650 nm in the same manner as the recordation of the information. The numerical aperture NA of the objective lens was set at 0.55. The linear velocity was set at 4.8[m/s]. The polarization plane of the laser beam was set in the direction perpendicular to the phase pit sequences 21 or the direction of tracking.

The inventor has also observed the electric signal output from the aforementioned subtracting amplifier 46 in the readout of the RAM information. An oscilloscope was employed for the observation. The reproduced waveform of the maximum amplitude value b appeared on the screen of the oscilloscope in a manner similar to the case of a general readout of the RAM information. The reproduced waveform of the minimum amplitude value a, smaller than the reproduced waveform of the maximum amplitude value b, also appeared on the screen of the oscilloscope in synchronization with the reproduced waveform of the maximum amplitude value b. The inventor measured the maximum and minimum amplitude values b, a of the electric signal based on such a duplex of the reproduced waveforms displayed on the oscilloscope in the same manner as described above.

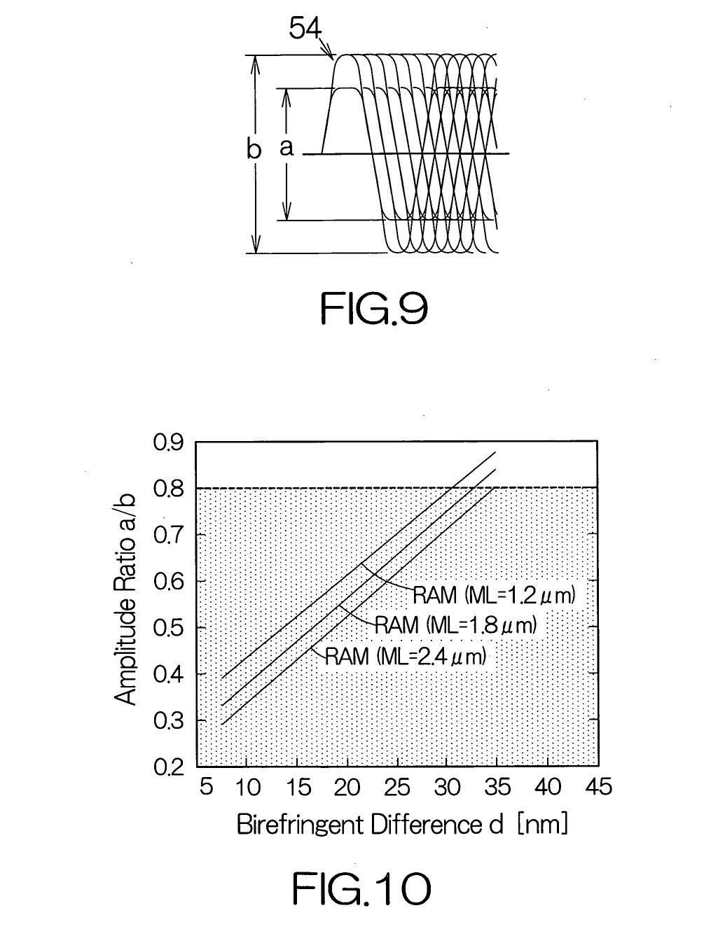

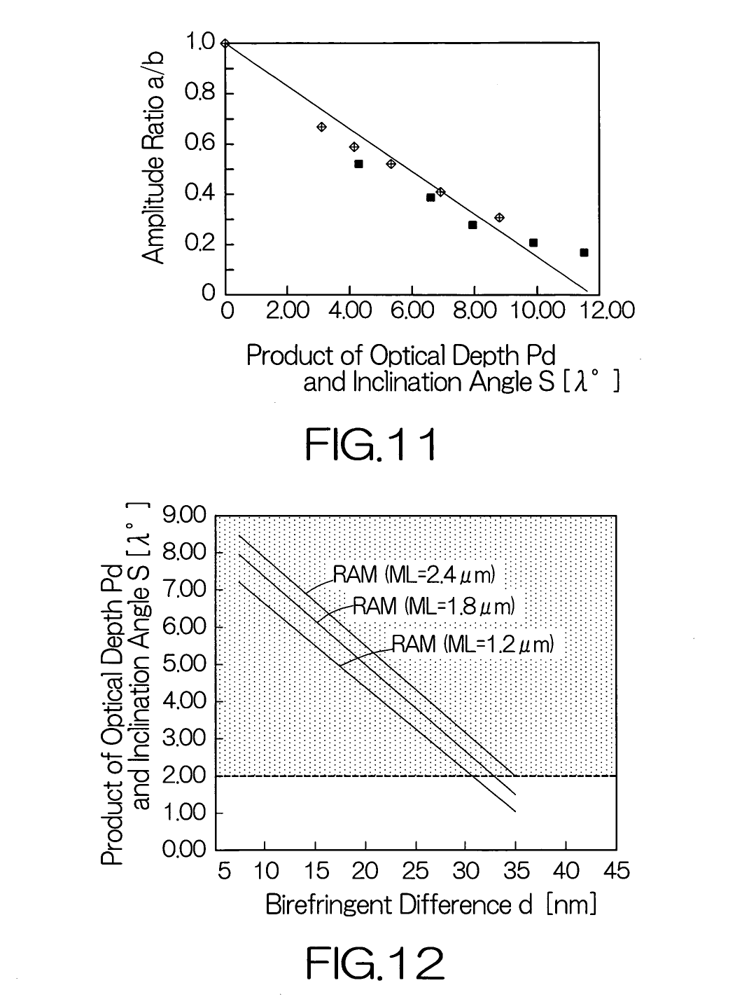

FIG. 10 is a graph showing the relationship between the amplitude ratio a/b and the birefringent difference. The dotted line in FIG. 10 stands for the maximum value of the amplitude ratio a/b required to obtain the ROM jitter equal to or smaller than 8%. If the amplitude ratio a/b exceeds the value of the dotted line, the ROM jitter exceeds 8%. The amplitude ratio a/b equal to or smaller than 0.8 enables a reliable realization of the ROM jitter equal to or smaller than 8% irrespective of the amount of the birefringent difference and/or the length of the minimum mark size ML. The solid line in FIG. 10 stands for the minimum value of the amplitude ratio a/b required to obtain the RAM jitter equal to or smaller than 8%. If the amplitude ratio a/b falls below the value of the solid line, the RAM jitter exceeds 8%. In this observation, when the minimum mark size ML is set twice the minimum pit length PL, the following relationship is established between the amplitude ratio a/b and the birefringent difference d[nm]:

[Expression 9]
a/b≧0.0177d+0.2568 (1)
When the minimum mark size ML is set three times the minimum pit length PL, the following relationship is established between the amplitude ratio a/b and the birefringent difference d[nm]:
[Expression 10]
a/b≧0.0185d+0.1918 (2)
When the minimum mark size ML is set four times the minimum pit length PL, the following relationship is established between the amplitude ratio a/b and the birefringent difference d[nm]:
[Expression 11]
a/b≧0.0186d+0.1506 (3)
In general, jitter equal to or smaller than 10% is required for recordation and reproduction of images and sound including music. Jitter equal to or smaller than 8% is required for recordation and reproduction of character and numeric data.

The inventor has observed the relationship between the aforementioned amplitude ratio a/b and the product PdS of the optical depth Pd of the phase pits 22 and the inclination angle S of the inclined surface 24. A predetermined correlation can be observed between the product PdS and the amplitude ratio a/b, as shown in FIG. 11.

FIG. 12 is a graph showing the relationship between the birefringent difference and the product PdS. The dotted line in FIG. 12 stands for the minimum value [λ°] of the product PdS required to obtain the ROM jitter equal to or smaller than 8%. If the value of the product PdS falls below the value of the dotted line, the ROM jitter exceeds 8%. The product PdS equal to or larger than 2.00 enables a reliable realization of the ROM jitter equal to or smaller than 8% irrespective of the amount of the birefringent difference and/or the length of the minimum mark size ML. The solid line in FIG. 12 stands for the maximum value [λ°] of the product PdS required to obtain the RAM jitter equal to or smaller than 8%. If the product PdS exceeds the value of the solid line, the RAM jitter exceeds 8%. When the minimum mark size ML is set twice the minimum pit length PL, the following relationship is established between the product PdS [λ°] and the birefringent difference d [nm] in this observation of the RAM jitter:

[Expression 12]
Pd·S≦−0.2236d+8.8616 (5)
When the minimum mark size ML is set three times the minimum pit length PL, the following relationship is established between the product PdS[λ°] and the birefringent difference d[nm]:
[Expression 13]
Pd·S≦−0.2338d+9.6817 (6)
When the minimum mark size ML is set four times the minimum pit length PL, the following relationship is established between the product PdS[λ°] and the birefringent difference d[nm]:
[Expression 14]
Pd·S≦−0.2345d+10.201 (7)

If the track pitch Tp is reduced below 1.0 μm in the magneto-optical disk 11 of the type, an interval gets narrower between the adjacent ones of the phase pit sequences 21 relative to the spot diameter of the laser beam 38. This results in generation of cross talk causing an increase in the ROM jitter and the RAM jitter. Referring to FIG. 10, for example, the solid lines of the RAM jitter shifts in the direction to increase the amplitude ratio a/b. To the contrary, the dotted line of the ROM jitter shifts in the direction to decrease the amplitude ratio a/b. This results in a reduction in the ranges of the amplitude ratio a/b required to keep the RAM jitter and the ROM jitter equal to or smaller than 8%. Likewise, the solid lines of the RAM jitter shifts in the direction to decrease the product PdS in FIG. 12. The dotted line of the ROM jitter shifts in the direction to increase the product PdS. This also results in a reduction in the ranges of the product PdS required to keep the RAM jitter and the ROM jitter equal to or smaller than 8%. If the track pitch Tp exceeds 1.2 μm, the recording density of the magneto-optical disk 11 gets reduced, although it is possible to avoid an increase in the ROM jitter and the RAM jitter.

If the minimum pit length PL falls below 0.55 μm in the magneto-optical disk 11, the minimum pit length PL is extremely reduced relative to the spot diameter of the laser beam 38. This results in a reduced resolution causing an increase in the ROM jitter. The dotted line of the ROM jitter in this case shifts in the direction to decrease the amplitude ratio a/b in FIG. 10, for example. The dotted line of the ROM jitter shifts in the direction to increase the product PdS in FIG. 12. The minimum pit length PL longer than 0.65 μm leads to a reduced recording density of the magneto-optical disk 11. It should be noted that, as long as the phase pit 22 of the maximum pit length is larger than the spot diameter of the laser beam 38, the solid line of the RAM jitter fails to suffer from influences from the minimum pit length PL of the phase pits 22 in FIGS. 10 and 12. The minimum phase pit PL fails to hinder the realization of the RAM jitter equal to or smaller than 8%.

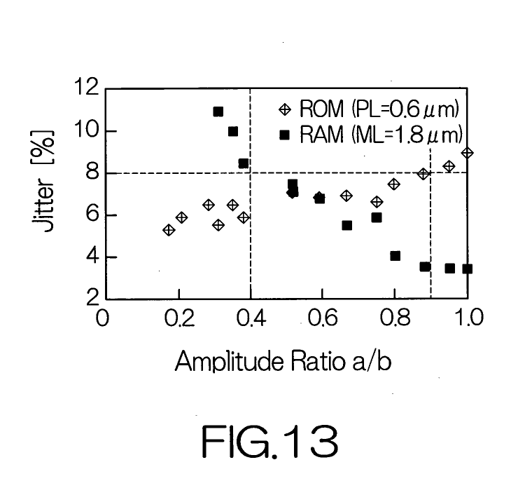

As shown in FIG. 13, the inventor has observed the variation of the ROM jitter and the RAM jitter in response to a change in the amplitude ratio a/b. As is apparent from FIG. 13, the larger the amplitude ratio a/b gets, the larger the ROM jitter becomes. If the amplitude ratio exceeds 0.9, the ROM jitter exceeds 8%. The larger the amplitude ratio a/b gets, the smaller the RAM jitter becomes. If the amplitude ratio a/b falls below 0.4, the RAM jitter exceeds 8%. It has been demonstrated that the amplitude ratio ranging from 0.4 to 0.9 enables a reliable realization of the jitter [%] of a sufficient reduction. It should be noted that the inventor utilized the fourth substrate 12 for the magneto-optical disk 11 in the observation. The recording marks 23 having the minimum mark size ML of 1.8 μm was written in the same manner as described above. The ROM information was read out based on the phase pit sequences 21 in the same manner as described above. The RAM information was also read out based on the recording marks 23.

As long as the aforementioned correlations are established between the spot diameter of the laser beam and the minimum pitch length PL as well as between the spot diameter and the track pitch Tp, the relationships shown in all the graphs are established. For example, the spot diameter of the laser beam is proportional to the wavelength λ of the laser beam while the spot diameter of the laser beam is inversely proportional to the numerical aperture NA. If the track pitch Tp is set in the range from 1.0×0.55/0.60 [μm] to 1.2×0.55/0.60 [μm], the relationships shown in all the graphs are established, even if the numerical aperture NA is changed from 0.55 to 0.60. The minimum pit length PL may be set in the range from 0.55×0.55/0.60 [μm] to 0.65×0.55/0.60 [μm]. The similar idea can also be applied to the wavelength λ. Any of the described relationships is maintained in the same manner irrespective of any change in the birefringence of the substrate 12.

What is claimed is:

1. A recording medium comprising:
a substrate defining phase pit sequences on a surface of the substrate; and
a magnetic film defining recording marks on the surface of the substrate based on a direction of magnetization, wherein
a following relationship is established between an amplitude ratio a/b and a birefringent difference d[nm], said amplitude ratio a/b being derived between a maximum amplitude value b of an electric signal and a minimum amplitude value a of the electric signal, said birefringent difference d[nm] being derived between first and second birefringent values,
[Expression 15]
a/b≧0.0177d+0.2568 (1)
said first birefringent value being measured for a single pass of an optical beam passing through the substrate of an attitude rotated by 20 degrees from a reference plane perpendicular to the optical beam around a tangent line extending through a spot of the optical beam on the substrate, said second birefringent value being measured for a single pass of the optical beam passing through the substrate of an attitude rotated by 20 degrees from the reference plane around a radial line extending through the spot of the optical beam on the substrate, said electric signal being generated in a photodetector based on optical beams having passing through the magnetic film, said optical beams having polarization planes perpendicular to each other.

2. The recording medium according to claim 1, wherein a following relationship is established:
[Expression 16]
a/b≧0.0185d+0.1918 (2)

3. The recording medium according to claim 2, wherein a following relationship is established:
[Expression 17]
a/b≧0.0186d+0.1506 (3)

4. The recording medium according to claim 3, wherein a following relationship is established:
[Expression 18]
a/b≦0.8 (4)

5. The recording medium according to claim 1, wherein a minimum mark size of the recording marks is set larger than a minimum pit length of phase pits in the phase pit sequences.

6. The recording medium according to claim 5, wherein the minimum mark size is set equal to a product of the minimum pit length and an integral.

7. The recording medium according to claim 1, wherein an interval is set in a range from 1.0 μm to 1.2 μm between adjacent ones of the phase pit sequences, the minimum pit length being set in a range from 0.55 μm to 0.65 μm.

8. A recording medium comprising:
a substrate defining phase pit sequences on a surface of the substrate; and
a magnetic film defining recording marks on the surface of the substrate based on a direction of magnetization, wherein
a following relationship is established between a birefringent difference d[nm] and a product of an optical depth Pd[λ] of phase pits in the phase pit sequences and an inclination angle S of an inclined surface defined in the phase pits, said birefringent difference d[nm] being derived between first and second birefringent values,
[Expression 19]
Pd·S≦−0.2236d+8.8616 (5)
said first birefringent value being measured for a single pass of an optical beam passing through the substrate of an attitude rotated by 20 degrees from a reference plane perpendicular to the optical beam around a tangent line extending through a spot of the optical beam on the substrate, said second birefringent value being measured for a single pass of the optical beam passing through the substrate of an attitude rotated by 20 degrees from the reference plane around a radial line extending through the spot of the optical beam on the substrate, and λ standing for a wavelength of an optical beam for readout of information.

9. The recording medium according to claim 8, wherein a following relationship is established:
[Expression 20]
Pd·S≦−0.2338d+9.6817 (6)

10. The recording medium according to claim 9, wherein a following relationship is established:
[Expression 21]
Pd·S≦−0.2345d+10.201 (7)

11. The recording medium according to claim 10, wherein a following relationship is established: [Expression 22]
Pd·S≧2.00 (8)

12. The recording medium according to claim 8, wherein a minimum mark size of the recording marks is set larger than a minimum pit length of phase pits in the phase pit sequences.

13. The recording medium according to claim 12, wherein the minimum mark size is set equal to a product of the minimum pit length and an integral.

14. The recording medium according to claim 8, wherein an interval is set in a range from 1.0 μm to 1.2 μm between adjacent ones of the phase pit sequences, the minimum pit length being set in a range from 0.55 μm to 0.65 μm.
